(19) United States
(12) Patent Application Publication
(10) Pub. No.: US 2005/0014083 A1
(43) Pub. Date: Jan. 20, 2005

(54) Dispersion polyermized microsphere particles

(76) Inventor: Jagdip N. Thaker, Schaumburg, IL (US)

Correspondence Address: MERONI + MERONI, P.O. BOX 309, BARRINGTON, IL, 60011, US

(21) Appl. No.: 10/621,528

(22) Filed: Jul. 17, 2003

(51) Int. Cl. G03G 9/08

(52) U.S. Cl. 430/110.1; 430/137.17; 524/425; 524/493; 524/437; 524/423; 524/447; 526/227; 526/232.1; 526/319; 526/346; 526/255; 526/344; 526/316; 524/556; 524/544

(57) ABSTRACT

The present invention provides a process for producing microsphere particles comprising the following steps: (a) charging to a first vessel water and a dispersion stabilizer and mixing to form a water phase, (b) charging co-monomers to second vessel at 60° C., (c) treating a charge control agent, a pigment and a micronized wax with a coupling agent, (d) charging to the second vessel the treated charge control agent, pigment and micronized wax of step (c), (e) charging and dissolving the polymerization initiator to the second vessel to form a co-monomer phase, (f) pumping the co-monomer phase of step (e) through a disperser at a rate of about one liter per hour while simultaneously pumping the water phase of step (a) through the disperser at a rate of about four liters into a polymerization reactor, (g) mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns, (h) mixing the slurry of polymerized microsphere particles in the polymerization reactor under vacuum and a temperature of about 85 degrees C. to remove any residual co-monomers, (i) acidifying the slurry to dissolve the dispersion stabilizer, (j) passing the slurry of step (i) through a centrifuge to remove water and dispersion stabilizer dissolved therein to provide centrifuged polymerized microsphere particles, and (k) washing the centrifuged polyermized microsphere particles with water until a pH of 7 is achieved. The present invention also provides color toners for use in digital laser printers and photocopiers as well as pharmaceutical and cosmetic products comprising polymerized microsphere particles produced by the process disclosed herein.

### FIELD OF THE INVENTION

The present invention relates to a process for producing microsphere particles for use as color toners in laser printers and photocopiers as well as pharmaceutical and medical products.

### BACKGROUND OF THE INVENTION

The most popular method of making microsphere particles is by emulsion polymerization in which these particles are grown from submicron size in the emulsion form. This process is not only very expensive, but requires a substantial amount of time. Moreover, the surfactants used as well as other impurities are impossible to remove. Furthermore, the particle size is very difficult to control, and large-scale production is nonexistent.

The purity of the microsphere particles and many other characteristics depend upon the total wetting of all of the additives by the monomer. If this does not occur, the color toners will have low yield, poor background, low solid area density and poor print quality. In the context of medical and cosmetic uses, impurities will render the microsphere particles useless.

Therefore, what is needed is a process whereby particle size can be easily controlled. What is also needed is a process wherein the microsphere particles produced are pure and can be used in printing systems as well as medical and cosmetic products.

### SUMMARY OF THE INVENTION

The present invention provides a process for producing microsphere particles comprising the following steps: (a) charging to a first vessel water and a dispersion stabilizer and mixing to form a water phase, (b) charging co-monomers to second vessel at 60° C., (c) treating a charge control agent, a pigment and a micronized wax with a coupling agent, (d) charging to the second vessel the treated charge control agent, pigment and micronized wax of step (c), (e) charging and dissolving the polymerization initiator to the second vessel to form a co-monomer phase, (f) pumping the co-monomer phase of step (e) through a disperser at a rate of about one liter per hour while simultaneously pumping the water phase of step (a) through the disperser at a rate of about four liters into a polymerization reactor, (g) mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns, (h) mixing the slurry of polymerized microsphere particles in the polymerization reactor under vacuum and a temperature of about 85 degrees C. to remove any residual co-monomers, (i) acidifying the slurry to dissolve the dispersion stabilizer, (j) passing the slurry of step (i) through a centrifuge to remove water and dispersion stabilizer dissolved therein to provide centrifuged polymerized microsphere particles, and (k) washing the centrifuged polyermized microsphere particles with water until a pH of 7 is achieved.

The present invention also provides color toners for use in digital laser printers and photocopiers as well as pharmaceutical and cosmetic products comprising polymerized microsphere particles produced by the process disclosed herein.

### DETAILED DESCRIPTION OF THE PREFERRED EMBODIMENTS

In a first embodiment, the present invention provides a process for producing microsphere particles comprising the following steps:
a. charging to a first vessel water and a dispersion stabilizer and mixing to form a water phase;
b. charging co-monomers to second vessel at 60° C.;
c. treating a charge control agent, a pigment and a micronized wax with a coupling agent;
d. charging to the second vessel the treated charge control agent, pigment and micronized wax of step (c);
e. charging and dissolving the polymerization initiator to the second vessel to form a co-monomer phase;
f. pumping the co-monomer phase of step (e) through a disperser at a rate of about one liter per hour while simultaneously pumping the water phase of step (a) through the disperser at a rate of about four liters into a polymerization reactor;
g. mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns;
h. mixing the slurry of polymerized microsphere particles in the polymerization reactor under vacuum and a temperature of about 85° C. to remove any residual co-monomers;
i. acidifying the slurry to dissolve the dispersion stabilizer;
j. passing the slurry of step (i) through a centrifuge to remove water and dispersion stabilizer dissolved therein to provide centrifuged polymerized microsphere particles; and
k. washing the centrifuged polyermized microsphere particles with water until a pH of 7 is achieved.

In a second embodiment, the process of the first embodiment further comprises the step of drying the centrifuged polymerized microsphere particles in a fluid bed dryer to provide dried polymerized microsphere particles.

In a third embodiment, the process of the second embodiment further comprises the step of mixing the dried polymerized microsphere particles with fumed silica in a high-intensity mixer to obtain toner.

In a fourth embodiment, the present invention provides A process for producing microsphere particles comprising the following steps:
a. charging to a first vessel water and a dispersion stabilizer and mixing to form a water phase;
b. charging co-monomers to second vessel at 60 degrees C.;
c. charging and dissolving the polymerization initiator to the second vessel to form a co-monomer phase;
d. pumping the co-monomer phase of step (c) through a disperser at a rate of about one liter per hour while simultaneously pumping the water phase of step (a) through the disperser at a rate of about four liters into a polymerization reactor;
e. mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns;
f. mixing the slurry of polymerized microsphere particles in the polymerization reactor under vacuum and a temperature of about 85° C. to remove any residual co-monomers;
g. acidifying the slurry to dissolve the dispersion stabilizer;
h. passing the slurry of step (g) through a centrifuge to remove water and dispersion stabilizer dissolved therein to provide centrifuged polymerized microsphere particles; and
i. washing the centrifuged polyermized microsphere particles with water until a pH of 7 is achieved.

In a fifth embodiment, the process of the fourth embodiment further comprises the step of drying the centrifuged polymerized microsphere particles in a fluid bed dryer to provide dried polymerized microsphere particles.

In a sixth embodiment, the present invention provides a polymerized microsphere particle by the process of the first embodiment.

In a seventh embodiment, the present invention provides a polymerized microsphere particle produced by the process of the second embodiment.

In an eighth embodiment, the present invention provides toner by the process of the third embodiment.

In a ninth embodiment, the present invention provides a polymerized microsphere particle produced by the process of the fourth embodiment

In a tenth embodiment, the present invention provides a microsphere particle produced by the process of the fifth embodiment.

The term “co-monomer” refers to two monomers selected from a group of compounds including acrylic monomers, vinyl monomers, methacrylic monomers and the like, such as, for example, styrene, o-methylstyrene, m-methylstyrene, p-methylstyrene, αi-methylstyrene, p-chlorostyrene, 3,4-dichlorostyrene, p-phenylstyrene, p-ethylstryene, 2,4-dimethylstyrene, p-tert-butylstyrene, p-n-hexylstyrene, p-n-octylstyrene, p-n-nonylstyrene, p-n-decylstyrene, p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethyl methacrylate, stearyl methacrylate, lauryl methacrylate, phenyl methacrylate, diethylaminoethyl methacrylate, dimethylaminoethyl methacrylate; acrylic acid esters and derivatives thereof such as methyl acrylate, ethyl acrylate, isopropyl acrylate, n-butyl acrylate, t-butylacrylate, isobutyl acrylate, n-octyl acrylate, 2-ethylhexyl acrylate, stearyl acrylate, lauryl acrylate, phenyl acrylate, and the like; olefins such as ethylene, propylene, isobutylene, and the like; halogen based vinyls such as vinyl chloride, vinylidene chloride, vinyl bromide, vinyl fluoride, vinylidene fluoride, and the like; vinyl esters such as vinyl propionate, vinyl acetate, vinyl benzoate, and the like; vinyl ethers such as vinyl methyl ether, vinyl ethyl ether, and the like; vinyl ketones such as vinyl methyl ketone, vinyl ethyl ketone, vinyl hexyl ketone, and the like; N-vinyl compounds such as N-vinylcarbazole, N-vinylindole, N-vinylpyrrolidone, and the like; vinyl compounds such as vinylnaphthalene, vinylpyridine, and the like; as well as derivatives of acrylic acid or methacrylic acid such as acrylonitrile, methacrylonitrile, and acryl amide. In one embodiment, styrene and n-butylacrylate are polymerizable co-monomers, wherein styrene is present in an amount of about 600 to about 1000 ml, preferably in an amount of about 700 to about 900 ml, and most preferably in an amount of about 850 ml, and wherein n-butylacrylate is present in an amount of about 50 to about 300 ml, preferably in an amount of about 100 to about 200 ml, and most preferably in an amount of about 150 ml.

The term “pigment” refers to colorants such as, for example, yellow colorants including but not limited thereto, chrome yellow, cadmium yellow, hansa yellow G, and the like. Other yellow colorants suitable for use in the present invention include condensed azo compounds, isoindolinone compounds, anthraquinone compounds, azo metal complexes, methine compounds and allylamide compounds such as, for example, C.I. Pigment Yellow 12, 13, 14, 15, 17, 62, 74, 83, 93, 94, 95, 109, 110, 111, 128, 129, 147 and 168, Toner Yellow 3 GP (Clariant); Red colorants suitable for use in the present invention include, for example, brilliant carmine 6B, eosine, red iron oxide, and the like; Blue colorants suitable for use in the present invention include, for example, phthalocyanine blue, Prussian blue, cobalt blue, and the like; Black colorants suitable for use in the present invention include, for example, carbon black such as furnace black, magnetic materials, channel black, and the like; Magenta colorants suitable for use in the present invention include condensed azo compounds, diketopyrrolopyrrole compounds, anthraquinone compounds, quinacridon compounds, basic dye lake compounds, naphthol compounds, benzimidazolone compounds, thioindigo compounds, and perylene compounds such as, for example, C.I. Pigment Red 2, 3, 5, 6, 7, 23, 48:2, 48:3, 48:4, 57:1, 81:1, 122, 144, 146, 166, 169, 177, 184, 185, 202, 206, 220, 221 and 254, Toner Magenta E 02 (Clariant); Cyan colorants suitable for use in the present invention include copper phthalocyanine compounds, their derivatives, anthraquinone compounds, and basic dye lake compounds such as, for example, C.I. Pigment blue 1, 7, 15, 15:1, 15:2, 15:3, 15:4, 60, 62 and 66, Cyan BG (Clariant). These colorants may be used individually, in combination. Alternatively, a magnetic toner can be prepared by incorporating magnetic powder as at least a part of the colorant. As the magnetic powder, there can be used, for example, powders of compounds or alloys which contain a ferromagnetic element such as iron, cobalt, nickel, etc. (e.g. ferrite, magnetite, etc.).

The term “charge control agents (CCAs)” refers to those compounds including: for color toners, a colorless CCA is preferred; negative toners, such as, for example, Bontron S-34, E-81, E-82, E-84, E-85, TRH from Hodogaya and the like; positive toners, such as, for example, quartemary ammonium salts or nogrosine dyes which are commercially available from Orient Corp. of America such as, for example, Bontron N-01, N-04, N-07 and the like. In one embodiment, Bontron E-84 is a CCA, and is present in an amount of about 0.1 to about 1.0% by weight of toner.

The term “wax” refers to any wax with melting point less than 70° C., and is used to provide anti-offset characteristics and. In one embodiment, wax is present in an amount of about, 1 to about 5% by weight of toner, preferably in an amount of about 2 to about 4% by weight of toner, and most preferably in an amount of about 3% by weight of toner.

The term “coupling agent” refers to compounds including, for example, titanate coupling agents such as neopentyl(diallyl)oxy trineodecanonyl titanate (LICA 01), neopentyl(diallyl)oxy tri(dodecyl)benzene-sulfonyl titanate (LICA 09), neopentyl(diallyl)oxy tri(dioctyl)phosphato titanate (LICA 12), neopentyl(diallyl)oxy tri(dioctyl)pyro-phosphato titanate (LICA 38), neopentyl(diallyl)oxy tri(N-ethylenediamino) ethyl titanate (LICA 44), neopentyl(diallyl)oxy tri(m-amino)phenyl titanate (LICA 97), and neopentyl(diallyl)oxy trihydroxy caproyl titanate (LICA 99) available from Kenrich Petrochemicals, Inc., New Jersey, USA. It is also contemplated that other coupling agents such as silane, zirconate and aluminate coupling agents can be used with the present invention. In one embodiment, LICA 38 is a titanate coupling agent, and is present in an amount of about 0.1 to about 10% by weight of toner, preferably in an amount of about 0.1 to about 1% by weight of toner, and most preferably in an amount of about 0.2% by weight of toner.

The term “polymerization initiators” refers to compounds including peroxide based polymerization initiators such as, for example, benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexane)propane, tris-(t-butylperoxy)triazine, and the like. In one embodiment, benzoyl peroxide is a polymerization inhibitor, and is present in an amount of about 0.5 to about 5.0% by weight of the polymerizable monomer.

The term “dispersion stabilizer” refers to compounds used to get toner particles by dispersion polymerization. An inorganic and/or organic dispersion stabilizer can be added to water (dispersion medium). Inorganic dispersion stabilizers suitable for use in the present invention include, for example, tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, alumina, and the like. Organic dispersion stabilizers suitable for use in the present invention include, for example, polyvinyl alcohol, gelatin, methyl cellulose, methylhydroxypropyl cellulose, ethyl cellulose, sodium dodecylbenzene sulfonate, ethylene oxide addition products and the like. In one embodiment, tricalcium phosphate is a dispersion stabilizer, and is present in an amount of about 0.2 to about 5.0 parts by weight of the polymerizable monomer.

The term “surfactant” refers to compounds including, for example, sodiumdodecylbenzenesulfonate, sodium oleate, sodium laurate and potassium stearate. In one embodiment, a surfactant is present in an amount of about 0 to about 1%, preferably in an amount of about 0.1 to about 0.5%, and most preferably in an amount of about 0.2%.

The present invention will hereinafter be described below in more detail by giving Examples, which, however, by no means limit the present invention.

### EXAMPLES

### Example 1

Water Phase

| | | |
|---|---|---|
| Deionized water | 5 | liters |
| Tricalcium Phosphate, AR grade | 250 | g |

Monomer Phase

| | | |
|---|---|---|
| Styrene | 850 | ml |
| n-Butylacrylate | 150 | ml |
| Bontron E-84 | 20 | g |
| Cyan BG | 50 | g |
| Benzoyl Peroxide | 20 | g |
| Wax, micronized | 35 | g |

To a first vessel was added water and tricalcium phosphate, and mixed with a high-speed mixer at about 60° C. for about 1 to about 15 minutes to provide a water phase. Then, to a second vessel the co-monomers were added and mixed in a lab mixer at about 60° C. Next, the charge control agent, pigment and micronized wax were treated with LICA 38, a titanate coupling agent. The LICA 38 treated charge control agent, pigment and micronized wax were then charged to the second vessel containing the co-monomers to provide a co-monomer phase.

In the IKA polymerization lab plant, the co-monomer phase was pumped through a disperser (DR 2000/4, IKA Works, Inc., Wilmington, N.C., USA) at a rate of about one liter per hour, and simultaneously, the water phase was also pumped through the disperser at a rate of about four liters per hour and into a polymerization reactor. The water and monomer phases were contacted together in the polymerization reactor having a paddle rotation speed of about 200 rpm (30 m/sec), temperature of about 75° C., for about four to about six hours to form a slurry of polymerized microsphere particles having a particle size from about 3 to about 20 microns. Nitrogen gas at ambient temperature and atmospheric pressure was passed over as a blanket during the complete process. After about four to about six hours, polymerization was continued under vacuum at a temperature of about 85° C. for about one or more hours to remove any residual co-monomers. Next, the slurry was acidified to dissolve the tricalcium phosphate, and the acidified slurry was passed through a centrifuge to remove the water and the tricalcium phosphate dissolved therein to provide centrifuged polymerized microsphere particles. The centrifuged polymerized microsphere particles were then washed with water until the wash water had a pH of 7.

Subsequently centrifuged polymerized microsphere particles dried in a fluid bed dryer. Finally, the dried polymerized microsphere particles were mixed with fumed silica R-972 (0.5%) (Degussa, USA) in a high intensity mixer such as, for example, a Henschel Mixer to prepare cyan toner for print test in an HP 4500 color printer (Hewlett Packard, USA).

### Example 2

Water Phase

| | | |
|---|---|---|
| Deionized water | 5 | liters |
| Tricalcium Phosphate, AR grade | 250 | g |

Monomer Phase

| | | |
|---|---|---|
| Styrene | 850 | ml |
| n-Butylacrylate | 150 | ml |
| Bontron E-84 | 20 | g |
| yellow 3 GP | 50 | g |
| Benzoyl Peroxide | 20 | g |
| Wax, micronized | 35 | g |

Yellow toner was prepared following the procedure described in Example 1 substituting Yellow 3 GP as the pigment. The resultant yellow toner had a particle size from about 3 to about 20 microns. These polymerized microsphere particles were mixed with fumed silica R-972 (0.5%) (Degussa, USA) in a high intensity mixer such as, for example, a Henschel Mixer to prepare yellow toner for print test in an HP 4500 color printer (Hewlett Packard, USA).

### Example 3

Water Phase

| | | |
|---|---|---|
| Deionized water | 5 | liters |
| Tricalcium Phosphate, AR grade | 250 | g |

Monomer Phase

| | | |
|---|---|---|
| Styrene | 850 | ml |
| n-Butylacrylate | 150 | ml |
| Bontron E-84 | 20 | g |
| Magenta E 02 | 50 | g |
| Benzoyl Peroxide | 20 | g |
| Wax, micronized | 35 | g |

Magenta toner was prepared following the procedure described in Example 1 substituting Magenta E 02 as the pigment. The resultant magenta toner had a particle size from about 3 to about 20 microns.

### Example 4

Cyan toner was prepared following the procedure described in Example 1 using a disperser different that the one used in Examples 1-3. The resultant cyan toner particle size distribution failed to meet the requirements because the quantity of large and/or small particles was to high producing poor print quality.

### Example 5

Cyan toner was prepared following the procedure described in Example 1 using an ultrasonic disperser. The resultant cyan toner particle size distribution failed to meet the requirements because the quantity of large and/or small particles was to high producing poor print quality.

### Example 6

For pharmaceutical or cosmetic uses, colorless microsphere particles can be produced using the process described hereinbelow. Surface binding proteins can be added for pharmaceutical and cosmetic uses. The resultant microsphere particles are added with compact powder composition.

Water Phase

| | | |
|---|---|---|
| Deionized water | 5 | liters |
| Tricalcium Phosphate, AR grade | 250 | g |

Monomer Phase

| | | |
|---|---|---|
| Styrene | 850 | ml |
| n-Butylacrylate | 150 | ml |
| Bontron E-84 | 20 | g |
| Benzoyl Peroxide | 20 | g |
| Wax, micronized | 35 | g |

To a first vessel was added water and tricalcium phosphate, and mixed with a high-speed mixer at about 60° C. for about one to about fifteen minutes.

Then, to a second vessel the co-monomers were added and mixed in a lab mixer at about 60° C. Next, the charge control agent and micronized wax were treated with LICA 38, a titanate coupling agent. The LICA 38 treated charge control agent and micronized wax were then charged to the second vessel containing the co-monomers to provide a co-monomer phase.

In the IKA polymerization lab plant, the co-monomer phase was pumped through a disperser (DR 2000/4, IKA Works, Inc., Wilmington, N.C., USA) at a rate of about one liter per hour, and simultaneously, the water phase was also pumped through the disperser at a rate of about four liters per hour and into a polymerization reactor. The water and monomer phases were contacted together in the polymerization reactor having a paddle rotation speed of about 200 rpm (30 m/sec), temperature of about 75° C., for about four to about six hours to form a slurry of polymerized microsphere particles having a particle size from about 3 to about 20 microns. Nitrogen gas at ambient temperature and atmospheric pressure was passed over as a blanket during the complete process. After about four to about six hours, polymerization was continued under vacuum at a temperature of about 85° C. for about one or more hours to remove any residual co-monomers. Next, the slurry was acidified to dissolve the tricalcium phosphate, and the acidified slurry was passed through a centrifuge to remove the water and the tricalcium phosphate dissolved therein to provide centrifuged polymerized microsphere particles. The centrifuged polymerized microsphere particles were washed carefully several times with distilled water until the wash water had a pH of 7. Subsequently washed polymerized microsphere particles were dried in a fluid bed dryer.

The resultant white microsphere particles have a particle size from about 3 to about 20 microns. By changing the setting of the disperser, different particle sizes can be prepared depending upon the medical and cosmetic applications.

1) A process for producing microsphere particles comprising the following steps:
a) charging to a first vessel water and a dispersion stabilizer and mixing to form a water phase;
b) charging co-monomers to second vessel at 60° C.;
c) treating a charge control agent, a pigment and a micronized wax with a coupling agent;
d) charging to the second vessel the treated charge control agent, pigment and micronized wax of step (c);
e) charging and dissolving the polymerization initiator to the second vessel to form a co-monomer phase;
f) pumping the co-monomer phase of step (e) through a disperser at a rate of about one liter per hour while simultaneously pumping the water phase of step (a) through the disperser at a rate of about four liters into a polymerization reactor;
g) mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns;
h) mixing the slurry of polymerized microsphere particles in the polymerization reactor under vacuum and a temperature of about 85° C. to remove any residual co-monomers;
i) acidifying the slurry to dissolve the dispersion stabilizer;
j) passing the slurry of step (i) through a centrifuge to remove water and dispersion stabilizer dissolved therein to provide centrifuged polymerized microsphere particles; and
k) washing the centrifuged polyermized microsphere particles with water until a pH of 7 is achieved.

2) The process of claim 1 wherein the dispersion stabilizer is selected from the group consisting tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, alumina, polyvinyl alcohol, gelatin, methyl cellulose, methylhydroxypropyl cellulose, ethyl cellulose, sodium dodecylbenzene sulfonate and ethylene oxide addition products.

3) The process of claim 2 wherein the dispersion stabilizer is tricalcium phosphate.

4) The process of claim 1 wherein the co-monomers are selected from the group consisting of styrene, o-methylstyrene, m-methylstyrene, p-methylstyrene, α-methylstyrene, p-chlorostyrene, 3,4-dichlorostyrene, p-phenylstyrene, p-ethylstryene, 2,4-dimethylstyrene, p-tert-butylstyrene, p-n-hexylstyrene, p-n-octylstyrene, p-n-nonylstyrene, p-n-decylstyrene, p-n-dodecylstyrene, methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethyl methacrylate, stearyl methacrylate, lauryl methacrylate, phenyl methacrylate, diethylaminoethyl methacrylate, dimethylaminoethyl methacrylate, methyl acrylate, ethyl acrylate, isopropyl acrylate, n-butyl acrylate, t-butylacrylate, isobutyl acrylate, n-octyl acrylate, 2-ethylhexyl acrylate, stearyl acrylate, lauryl acrylate, phenyl acrylate, ethylene, propylene, isobutylene, vinyl chloride, vinylidene chloride, vinyl bromide, vinyl fluoride, vinylidene fluoride, vinyl propionate, vinyl acetate, vinyl benzoate, vinyl methyl ether, vinyl ethyl ether, vinyl methyl ketone, vinyl ethyl ketone, vinyl hexyl ketone, N-vinylcarbazole, N-vinylindole, N-vinylpyrrolidone, vinylnaphthalene, vinylpyridine, acrylonitrile, methacrylonitrile and acryl amide.

5) The process of claim 5 wherein the co-monomers are styrene and n-butylacrylate.

6) The process of claim 1 wherein the charge control agent is selected from the group consisting of Bontron S-34, Bontron E-81, Bontron E-82, Bontron E-84, Bontron E-85, Bontron TRH, quartemary ammonium salts, nogrosine dyes, Bontron N-01, Bontron N-04 and Bontron N-07.

7) The process of claim 7 wherein the charge control agent is Bontron E-84.

8) The process of claim 1 wherein the pigment is selected from the group consisting of chrome yellow, cadmium yellow, hansa yellow G, condensed azo compounds, isoindolinone compounds, anthraquinone compounds, azo metal complexes, methine compounds, allylamide compounds, C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 109, C.I. Pigment Yellow 110, C.I. Pigment Yellow 111, C.I. Pigment Yellow 128, C.I. Pigment Yellow 129, C.I. Pigment Yellow 147, C.I. Pigment Yellow 168, Toner Yellow 3 GP, brilliant carmine 6B, eosine, red iron oxide, phthalocyanine blue, Prussian blue, cobalt blue, carbon black, furnace black, magnetic materials, channel black, condensed azo compounds, diketopyrrolopyrrole compounds, anthraquinone compounds, quinacridon compounds, basic dye lake compounds, naphthol compounds, benzimidazolone compounds, thioindigo compounds, perylene compounds, C.I. Pigment Red 2, C.I. Pigment Red 3, C.I. Pigment Red 5, C.I. Pigment Red 6, C.I. Pigment Red 7, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, C.I. Pigment Red 254, Toner Magenta E 02, copper phthalocyanine compounds, anthraquinone compounds, C.I. Pigment blue 1, C.I. Pigment blue 7, C.I. Pigment blue 15, C.I. Pigment blue 15:1, C.I. Pigment blue 15:2, C.I. Pigment blue 15:3, C.I. Pigment blue 15:4, C.I. Pigment blue 60, C.I. Pigment blue 62, C.I. Pigment blue 66 and Cyan BG.

9) The process of claim 1 wherein the polymerization initiator is selected from the group consisting of benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexane)propane and tris-(t-butylperoxy)triazine.

10) The process of claim 1 wherein the micronized wax has a melting point less than 70° C.

11) The process of claim 1 wherein the coupling agent is a titanate coupling agent.

12) The process of claim 11 wherein the titanate coupling agent is selected from the group consisting of neopentyl(diallyl)oxy trineodecanonyl titanate (LICA 01), neopentyl(diallyl)oxy tri(dodecyl)benzene-sulfonyl titanate (LICA 09), neopentyl(diallyl)oxy tri(dioctyl)phosphato titanate (LICA 12), neopentyl(diallyl)oxy tri(dioctyl)pyro-phosphato titanate (LICA 38), neopentyl(diallyl)oxy tri(N-ethylenediamino) ethyl titanate (LICA 44), neopentyl(diallyl)oxy tri(m-amino)phenyl titanate (LICA 97), and neopentyl(diallyl)oxy trihydroxy caproyl titanate (LICA 99).

13) The process of claim 12 wherein the titanate coupling agent is neopentyl(diallyl)oxy tri(dioctyl)pyro-phosphato titanate (LICA 38).

14) The process of claim 1 further comprising the step of drying the centrifuged polymerized microsphere particles in a fluid bed dryer to provide dried polymerized microsphere particles.

15) The process of claim 14 further comprising the step of mixing the dried polymerized microsphere particles with fumed silica in a high-intensity mixer to obtain toner.

16) A process for producing microsphere particles comprising the following steps:
a. charging to a first vessel water and a dispersion stabilizer and mixing to form a water phase;
b. charging co-monomers to second vessel at 60 degrees C.;
c. charging and dissolving the polymerization initiator to the second vessel to form a co-monomer phase;
d. pumping the co-monomer phase of step (c) through a disperser at a rate of about one liter per hour while simultaneously pumping the water phase of step (a) through the disperser at a rate of about four liters into a polymerization reactor;
e. mixing the water and monomer phases together in the polymerization reactor having a paddle rotation speed of about 200 rpm (30 m/sec) at a temperature of about 75° C. for about four to about six hours under an inert atmosphere to form a slurry of polymerized microsphere particles having a particle size from about 3 to about 20 microns;
f. mixing the slurry of polymerized microsphere particles in the polymerization reactor under vacuum and a temperature of about 85° C. to remove any residual co-monomers;
g. acidifying the slurry to dissolve the dispersion stabilizer;
h. passing the slurry of step (g) through a centrifuge to remove water and dispersion stabilizer dissolved therein to provide centrifuged polymerized microsphere particles; and
i. washing the centrifuged polyermized microsphere particles with water until a pH of 7 is achieved.

17) The process of claim 16 further comprising the step of drying the centrifuged polymerized microsphere particles in a fluid bed dryer to provide dried microsphere particles.

18) A microsphere particle produced by the process of claim 1.

19) A color toner for use in a laser printer comprising the microsphere particle of claim 18.

20) A color toner for use in a photocopier comprising the microsphere particle of claim 18.
